(19) United States
(12) Patent Application Publication
(10) Pub. No.: US 2020/0238456 A1
(43) Pub. Date: Jul. 30, 2020

(54) SAWING AND DRILLING COMBINED MACHINING DEVICE

(71) Applicant: CITIC Dicastal CO., LTD., Qinhuangdao (CN)

(72) Inventor: Fengbao LUO, Qinhuangdao (CN)

(73) Assignee: CITIC Dicastal CO., LTD., Qinhuangdao (CN)

(21) Appl. No.: 16/551,518

(22) Filed: Aug. 26, 2019

(30) Foreign Application Priority Data
Jan. 30, 2019 (CN) 201910093133.0

(51) Int. Cl. B23P 23/02; B23B 39/16; B23D 45/10

(52) U.S. Cl. CPC B23P 23/02; B23D 45/10; B23B 39/16

(57) ABSTRACT

A sawing and drilling combined machining device includes a frame, a clamping mechanism, a sawing mechanism and a drilling mechanism; the frame includes a first end for mounting the clamping mechanism, a second end for mounting the drilling mechanism, and a third end for mounting the sawing mechanism, the first end and the second end are two opposite ends of the frame in a horizontal direction, and the third end is at an upper end or a lower end of the frame between the first end and the second end.

### CROSS-REFERENCE TO RELATED APPLICATION

The present application claims benefit of Chinese Patent Application No. 201910093133.0, filed on Jan. 30, 2019, the contents of which are hereby incorporated by reference in their entirety.

### BACKGROUND

At present, after the casting of a differential pressure cast aluminum alloy knuckle blank is completed, pre-machining is required before heat treatment. The purpose of the pre-machining is to remove a gate of the differential pressure aluminum alloy casting and machine a center hole matching an automobile axle. The reasons are as follows: 1) there is an iron filter in the gate, which has an effect on the performance of the casting during the heat treatment; and 2) there is more machining allowance in the center hole, and most of the machining allowance needs to be removed before the heat treatment when the material of the knuckle blank is not very hard.

The existing method for sawing the gate and drilling the center hole includes machining on different machines in two steps. The blank is positioned and clamped on a sawing machine through a clamping mechanism to saw off the gate, and positioned and clamped again on a drilling machine through a clamping mechanism to drill the center hole. For the machining on different machines, two sets of positioning and clamping mechanisms and two times of clamping are required, which not only increases the machining time, but also is prone to large positioning deviation caused by the two times of clamping, resulting in large deviation of the machining size and even scrap of the casting.

### SUMMARY

The present disclosure relates to a machining technology, in particular to a sawing and drilling combined machining device.

In view of this, embodiments of the present disclosure are desired to provide a sawing and drilling combined machining device, which reduces machining time and avoids clamping errors during machining.

In order to achieve the above objective, the technical solution of the present disclosure is implemented as follows:

Embodiments of the present disclosure provide a sawing and drilling combined machining device, including a frame, a clamping mechanism, a sawing mechanism and a drilling mechanism; the frame includes a first end for mounting the clamping mechanism, a second end for mounting the drilling mechanism, and a third end for mounting the sawing mechanism, the first end and the second end are two opposite ends of the frame in a horizontal direction, and the third end is at an upper end or a lower end of the frame between the first end and the second end.

The clamping mechanism includes a rotating portion and a clamping portion for fixing a part to be machined, the rotating portion is fixed to one end of the clamping portion, and the clamping mechanism rotates relative to the frame about a horizontal axis or a vertical axis through the rotating portion; in the machining process of the sawing mechanism and the drilling mechanism, the clamping portion is fixed to the frame.

The sawing mechanism includes a first driving portion and a sawing machine, and the sawing machine moves to the part to be machined under the drive of the first driving portion to implement sawing; the first driving portion is fixed to the frame.

The drilling mechanism includes a second driving portion and a drilling machine, and the drilling machine moves to the part to be machined under the drive of the second driving portion to implement drilling; and the second driving portion is fixed to the frame.

In the embodiment, when the clamping portion is fixed to the frame, the rotating portion is at the bottom of the first end; the clamping mechanism rotates relative to the frame about the horizontal axis through the rotating portion. The third end is at the upper end of the frame between the first end and the second end, and when the sawing machine saws the part to be machined under the drive of the first driving portion, the sawing machine moves from top to bottom.

In the embodiment, the sawing mechanism further includes a first movable plate, and the sawing machine is fixed to the first movable plate; one end of the first movable plate is connected to the first driving portion, and the first movable plate moves linearly up and down relative to the frame.

In the embodiment, the first driving portion includes a vertical rotating component and a vertical lead screw, one end of the vertical lead screw is rotatably fixed to the vertical rotating component, and the other end of the vertical lead screw penetrates through the first movable plate and is rotatably fixed to the frame; the vertical lead screw is driven to rotate by the vertical rotating component, and the first movable plate includes a vertical threaded hole matching the vertical lead screw.

In the embodiment, the drilling mechanism further includes a second movable plate, and the drilling machine is fixed to the second movable plate; one end of the second movable plate is connected to the second driving portion, and the second movable plate moves horizontally and linearly relative to the frame.

In the embodiment, the second driving portion includes a horizontal rotating component and a horizontal lead screw, one end of the horizontal lead screw is rotatably fixed to the horizontal rotating component, and the other end of the horizontal lead screw penetrates through the second movable plate and is rotatably fixed to the frame; the horizontal lead screw is driven to rotate by the horizontal rotating component, and the second movable plate includes a horizontal threaded hole matching the horizontal lead screw.

In the embodiment, in the machining process of the sawing mechanism and the drilling mechanism, the clamping mechanism is fixed to the frame through a hydraulic lock, the hydraulic lock includes a fixed portion fixed to the frame and an ejector rod for restricting the rotation of the clamping mechanism, and the ejector rod continuously presses against the clamping mechanism under hydraulic power to restrict the rotation of the clamping mechanism.

In the embodiment, the frame is rectangular, and the middle of the frame includes an accommodating space for accommodating the sawing machine and the drilling machine; the first end and the second end are respectively side end plates at two ends of the accommodating space, the third end is a top end plate of the accommodating space, and the second movable plate is mounted on a bottom plate of the accommodating space in a sliding manner.

In the embodiment, the sawing mechanism further includes a vertical guide pillar, at least one end of the vertical guide pillar is fixed to the frame, the first movable plate further includes a vertical guide hole matching the vertical guide pillar, and the first movable plate moves linearly up and down along the vertical guide pillar.

In the embodiment, the drilling mechanism further includes a horizontal guide block, and the horizontal guide block is fixed to the bottom plate of the accommodating space; the second movable plate further includes a horizontal guide slot matching the horizontal guide block, and the second movable plate moves horizontally and linearly along the horizontal guide block.

The sawing and drilling combined machining device according to the embodiments of the present disclosure includes a frame, a clamping mechanism, a sawing mechanism and a drilling mechanism; the frame includes a first end for mounting the clamping mechanism, a second end for mounting the drilling mechanism, and a third end for mounting the sawing mechanism, the first end and the second end are two opposite ends of the frame in a horizontal direction, and the third end is at an upper end or a lower end of the frame between the first end and the second end. By combining the clamping mechanism, the sawing mechanism and the drilling mechanism together, the sawing and drilling combined machining device according to the embodiments of the present disclosure completes sawing and drilling by one clamping, thereby reducing the machining time and avoiding clamping errors during machining.

Other advantageous effects of the embodiments of the present disclosure will be further described in conjunction with specific technical solutions in the specific embodiments.

### BRIEF DESCRIPTION OF DRAWINGS

To describe the technical solutions of the embodiments of the present disclosure more clearly, the accompanying drawings required for describing the embodiments will be described briefly below. It should be understood that the drawings described below are only some of the drawings of the present disclosure, and other drawings may also be obtained by those of ordinary skill in the art according to the drawings without any creative efforts.

FIG. 1 is a first schematic diagram of a knuckle blank sawing and drilling combined machining device according to an embodiment of the present disclosure;

FIG. 2 is a second schematic diagram of a knuckle blank sawing and drilling combined machining device according to an embodiment of the present disclosure;

FIG. 3 is a schematic diagram of a clamping mechanism in the knuckle blank sawing and drilling combined machining device according to an embodiment of the present disclosure;

FIG. 4 is a schematic diagram of a sawing mechanism in the knuckle blank sawing and drilling combined machining device according to an embodiment of the present disclosure;

FIG. 5 is a schematic diagram of a drilling mechanism in the knuckle blank sawing and drilling combined machining device according to an embodiment of the present disclosure;

FIG. 6 is a schematic diagram of a frame in the knuckle blank sawing and drilling combined machining device according to an embodiment of the present disclosure.

### DETAILED DESCRIPTION

It should be noted that, in the description of the embodiments of the present disclosure, unless otherwise stated and limited, the term “connected” shall be understood broadly, for example, it may be an electrical connection, an internal communication between two components, a direct connection, or an indirect connection by an intermediate medium, and the specific meaning of the term may be understood by those of ordinary skill in the art according to the specific circumstances.

It should be noted that, the terms “first/second/third” involved in the embodiments of the present disclosure are only intended to distinguish similar objects, but do not represent specific orders of the objects, and understandably, the “first\second\third” may be interchanged in a specific order or a precedence order if allowed.

Embodiments of the present disclosure provide a sawing and drilling combined machining device, including a frame, a clamping mechanism, a sawing mechanism and a drilling mechanism; the frame includes a first end for mounting the clamping mechanism, a second end for mounting the drilling mechanism, and a third end for mounting the sawing mechanism, the first end and the second end are two opposite ends of the frame in a horizontal direction, and the third end is at an upper end or a lower end of the frame between the first end and the second end; the clamping mechanism includes a rotating portion and a clamping portion for fixing a part to be machined, the rotating portion is fixed to one end of the clamping portion, and the clamping mechanism rotates relative to the frame about a horizontal axis or a vertical axis through the rotating portion; in the machining process of the sawing mechanism and the drilling mechanism, the clamping portion is fixed to the frame; the sawing mechanism includes a first driving portion and a sawing machine, and the sawing machine moves to the part to be machined under the drive of the first driving portion to implement sawing; the first driving portion is fixed to the frame; the drilling mechanism includes a second driving portion and a drilling machine, and the drilling machine moves to the part to be machined under the drive of the second driving portion to implement drilling; and the second driving portion is fixed to the frame.

By combining the clamping mechanism, the sawing mechanism and the drilling mechanism together, the sawing and drilling combined machining device according to the embodiments of the present disclosure completes sawing and drilling by one clamping, thereby reducing the machining time and avoiding clamping errors during machining.

The present disclosure will be described in detail below with reference to the accompanying drawings and specific embodiments. It should be understood that the specific embodiments described herein are merely used for interpreting the present disclosure, rather than limiting the present disclosure. In addition, the embodiments described below are only part of the embodiments of the present disclosure, not all of them. All other embodiments obtained by those of ordinary skill in the art based on these embodiments without any creative efforts fall into the scope of the present disclosure.

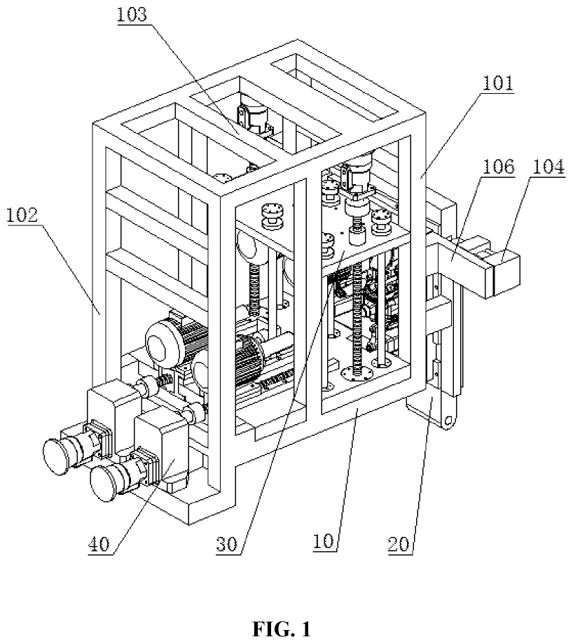

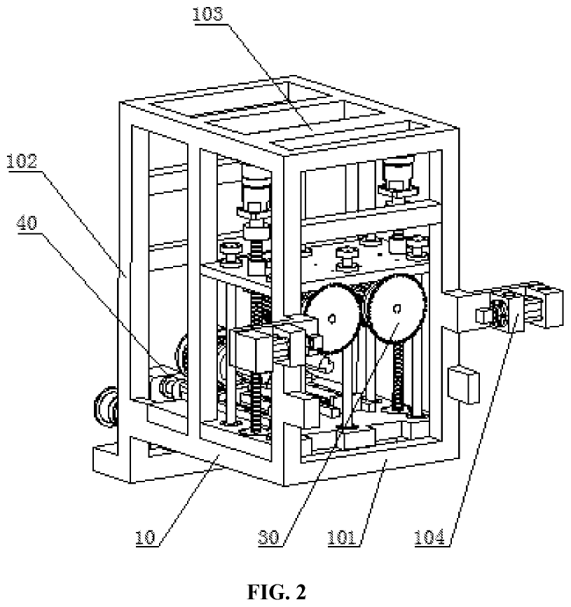

FIG. 1 is a first schematic diagram of a knuckle blank sawing and drilling combined machining device according to an embodiment of the present disclosure, and FIG. 2 is a second schematic diagram of the knuckle blank sawing and drilling combined machining device according to an embodiment of the present disclosure. In FIG. 2, in order to view the sawing mechanism clearly, the clamping mechanism is removed. In this embodiment, the sawing and drilling combined machining device is used for pre-machining of a knuckle blank, and understandably, can also be used for machining of other parts.

As shown in FIGS. 1 and 2, the knuckle blank 50 sawing and drilling combined machining device includes a frame 10, a clamping mechanism 20, a sawing mechanism 30, and a drilling mechanism 40. The frame 10 includes a first end 101 for mounting the clamping mechanism 20, a second end 102 for mounting the drilling mechanism 40, and a third end 103 for mounting the sawing mechanism 30. The first end 101 and the second end 102 are two opposite ends of the frame 10 in a horizontal direction, and the third end 103 is at an upper end of the frame 10 between the first end 101 and the second end 102.

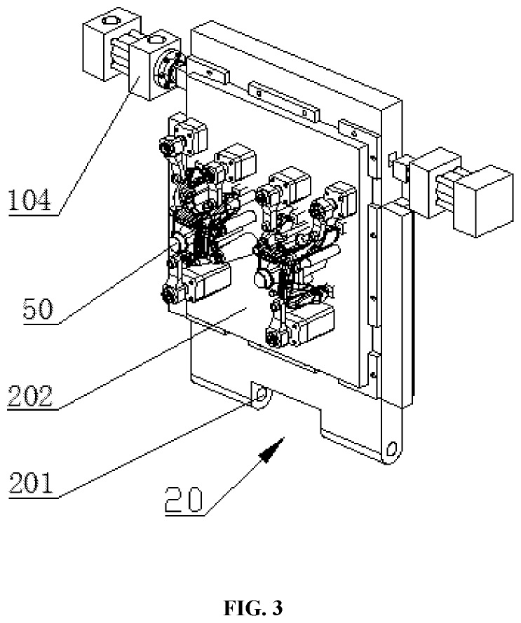

As shown in FIG. 3, the clamping mechanism 20 includes a rotating portion 201 and a clamping portion 202 for fixing the knuckle blank 50. The rotating portion 201 is fixed to one end of the clamping portion 202, and the clamping mechanism 20 rotates relative to the frame 10 about a horizontal axis through the rotating portion 201. In the machining process of the sawing mechanism 30 and the drilling mechanism 40, the clamping portion 202 is fixed to the frame 10. When the clamping portion 202 is fixed to the frame 10, the rotating portion 201 is at the bottom of the first end 101. Specifically, the rotating portion 201 is a shaft hole in a horizontal direction. The frame 10 includes a pin that cooperates with the shaft hole. The clamping portion 202 rotates downward using the bottom rotating portion 201 as a shaft. After the knuckle blank 50 is clamped, i.e., fed, the clamping portion 202 rotates toward an opposite direction and is fixed to the frame 10 to start machining. In this way, feeding or discharging is more convenient and more efficient.

For the positioning and fixing of the knuckle blank 50, corresponding positioning structures and fixing parts are arranged on the clamping portion 202 according to the principle of mechanical positioning, and details are not described here. In addition, the specific structure of the knuckle blank 50 is not the content of the present disclosure, and the drawing of the knuckle blank 50 is not otherwise shown.

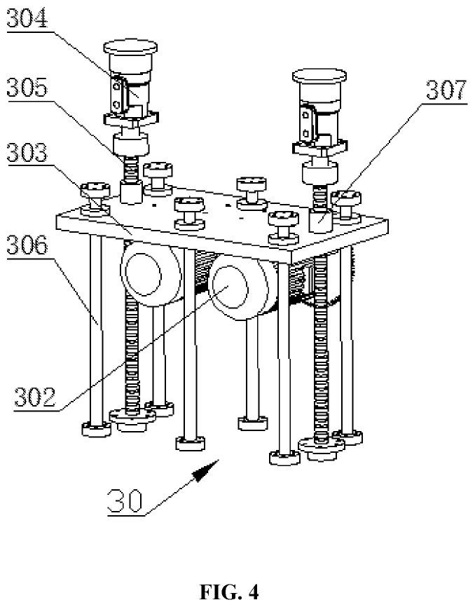

As shown in FIG. 4, the sawing mechanism 30 includes a first driving portion and a sawing machine 302. The sawing machine 302 moves toward the knuckle blank 50 under the drive of the first driving portion to implement sawing, that is, the sawing machine 302 moves from top to bottom. The first driving portion is fixed to the frame 10. Specifically, the sawing machine 302 includes a first motor and a circular saw blade (not in the drawings).

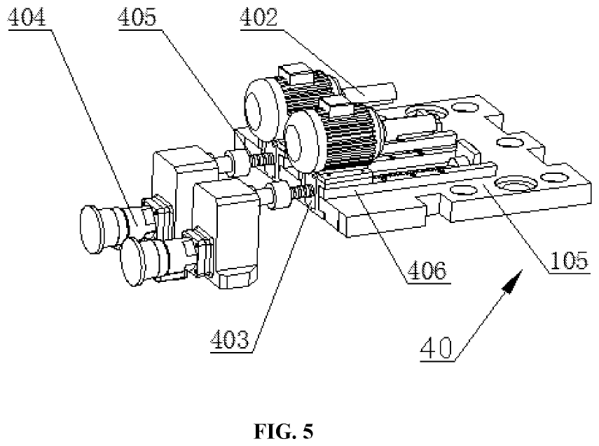

As shown in FIG. 5, the drilling mechanism 40 includes a second driving portion and a drilling machine 402. The drilling machine 402 moves toward the knuckle blank 50 under the drive of the second driving portion to implement drilling. The second driving portion is fixed to the mechanism. Specifically, the drilling machine includes a second motor and a drill bit (not shown in the drawings).

It can be understood that the third end 103 may also be at the lower end of the frame 10 between the first end 101 and the second end 102. During the sawing mechanism 30 implements sawing, the sawing machine 302 moves from bottom to top.

It can also be understood that the rotating portion 201 may be a pin, or a pin or shaft hole in a vertical direction and the clamping mechanism 20 may also rotate about a vertical axis through the rotating portion 201 to implement feeding or discharging.

The sawing mechanism 30 further includes a first movable plate 303, and the sawing machine 302 is fixed to the first movable plate 303; one end of the first movable plate 303 is connected to the first driving portion, and the first movable plate 303 moves linearly up and down relative to the frame 10. The movement is more stable through up-down movement of the movable plate. It can be understood that the sawing mechanism 30 may also be other sawing structure. For example, the first driving portion may also directly drive the sawing machine 302.

The first driving portion includes a vertical rotating component 304 and a vertical lead screw 305, one end of the vertical lead screw 305 is rotatably fixed to the vertical rotating component 304, and the other end of the vertical lead screw 305 penetrates through the first movable plate 303 and is rotatably fixed to the frame 10. The vertical lead screw 305 is driven to rotate by the vertical rotating component 304, and the first movable plate 303 includes a vertical threaded hole matching the vertical lead screw 305. The rotation of the lead screw is converted into the linear movement of the movable plate, so that stable and uniform movement can be achieved, and the movement accuracy is high. It can be understood that other methods are also possible, for example, the movable plate is driven to move by a hydraulic cylinder. In this embodiment, the vertical rotating component is a hydraulic motor.

The drilling mechanism 40 further includes a second movable plate 403, and the drilling machine 402 is fixed to the second movable plate 403; one end of the second movable plate 403 is connected to the second driving portion and the second movable plate 403 moves horizontally and linearly relative to the frame 10. The movement is more stable through up-down movement of the movable plate. It can be understood that the drilling mechanism 40 may also be other drilling structure. For example, the first driving portion may also directly drive the drilling machine 402.

The second driving portion includes a horizontal rotating component 404 and a horizontal lead screw 405, one end of the horizontal lead screw 405 is rotatably fixed to the horizontal rotating component 404, and the other end of the horizontal lead screw 405 penetrates through the second movable plate 403 and is rotatably fixed to the frame 10. The horizontal lead screw 405 is driven to rotate by the horizontal rotating component 404, and the second movable plate 403 includes a horizontal threaded hole matching the horizontal lead screw 405. The rotation of the lead screw is converted into the linear movement of the movable plate, so that stable and uniform movement can be achieved, and the movement accuracy is high. It can be understood that other methods are also possible, for example, the movable plate is driven to move by a hydraulic cylinder. In this embodiment, the horizontal rotating component is a hydraulic motor.

In the machining process of the sawing mechanism 30 and the drilling mechanism 40, the clamping mechanism 20 is fixed to the frame 10 through a hydraulic lock 104, the hydraulic lock 104 includes a fixed portion fixed to the frame 10 and an ejector rod for restricting the rotation of the clamping mechanism 20, and the ejector rod continuously presses against the clamping mechanism 20 under hydraulic power to restrict the rotation of the clamping mechanism 20. The hydraulic lock 104 is convenient and quick to fix, and can achieve automatic locking and unlocking with high efficiency. It can be understood that other fixing methods such as plugs, a bayonet lock or bolts are also available. Specifically, the hydraulic lock is fixed to an L-shaped mounting rack 106 of the frame 10.

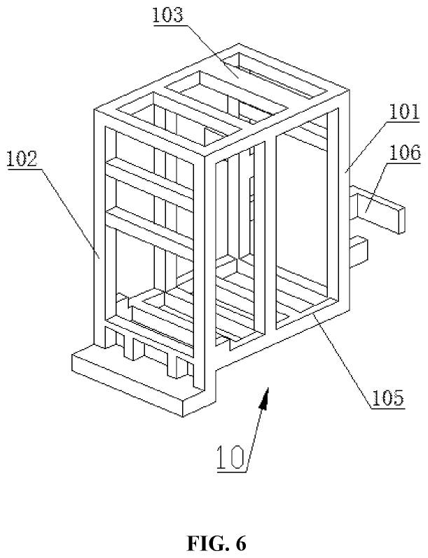

As shown in FIG. 6, the frame 10 is rectangular, and the middle of the frame 10 includes an accommodating space for accommodating the sawing machine 302 and the drilling machine 402. The first end 101 and the second end 102 are respectively side end plates at two ends of the accommodating space, the third end 103 is a top end plate of the accommodating space, and the second movable plate 403 is mounted on a bottom plate 105 of the accommodating space in a sliding manner. Thus, the machining is more convenient, and the clamping mechanism 20, the sawing mechanism 30, and the drilling mechanism 40 are more convenient to mount. It can be understood that other shapes are also available.

The sawing mechanism 30 further includes a vertical guide pillar 306, one end of the vertical guide pillar 306 is fixed to the frame 10 and the other end is connected to the first movable plate, the first movable plate 303 further includes a vertical guide hole matching the vertical guide pillar 306, and the first movable plate 303 moves linearly up and down along the vertical guide pillar 306. Thus, the linearity of up-down linear movement of the first movable plate 303 is better. The movement by the lead screw requires screw rotation, which has certain radial gap, so the linearity is poor. It can be understood that the guide pillar may also not be provided, for the precision of the lead screw itself is relatively high. Although the precision is not as high as that of the guide pillar, it can satisfy machining in most cases.

The first movable plate 303 is further provided with a threaded sleeve 307, the threaded sleeve 307 is fixed to the first movable plate, and a threaded hole matching the vertical lead screw 305 is formed in the threaded sleeve 307. Thus, the first movable plate 303 is simpler to machine.

The drilling mechanism 40 further includes a horizontal guide block 406, and the horizontal guide block 406 is fixed to the bottom plate 105 of the accommodating space. The second movable plate 403 further includes a horizontal guide slot matching the horizontal guide block 406, and the second movable plate 403 moves horizontally and linearly along the horizontal guide block 406. Similarly, the movement of the guide block can achieve better linearity than the lead screw.

The foregoing descriptions are merely preferred embodiments of the present disclosure, but are not intended to limit the protection scope of the present disclosure. Any modifications, equivalent substitutions, improvements and the like made within the spirit and principle of the present disclosure shall fall within the protection scope of the present disclosure.

1. A sawing and drilling combined machining device, comprising a frame, a clamping mechanism, a sawing mechanism and a drilling mechanism, wherein the frame comprises a first end for mounting the clamping mechanism, a second end for mounting the drilling mechanism, and a third end for mounting the sawing mechanism, the first end and the second end are two opposite ends of the frame in a horizontal direction, and the third end is at an upper end or a lower end of the frame between the first end and the second end;
the clamping mechanism comprises a rotating portion and a clamping portion for fixing a part to be machined, the rotating portion is fixed to one end of the clamping portion, and the clamping mechanism rotates relative to the frame about a horizontal axis or a vertical axis through the rotating portion; in the machining process of the sawing mechanism and the drilling mechanism, the clamping portion is fixed to the frame;
the sawing mechanism comprises a first driving portion and a sawing machine, and the sawing machine moves to the part to be machined under the drive of the first driving portion to implement sawing; the first driving portion is fixed to the frame;
the drilling mechanism comprises a second driving portion and a drilling machine, and the drilling machine moves to the part to be machined under the drive of the second driving portion to implement drilling; and the second driving portion is fixed to the frame.

2. The sawing and drilling combined machining device according to claim 1, wherein when the clamping portion is fixed to the frame, the rotating portion is at the bottom of the first end; the clamping mechanism rotates relative to the frame about the horizontal axis through the rotating portion;
the third end is at the upper end of the frame between the first end and the second end, and when the sawing machine saws the part to be machined under the drive of the first driving portion, the sawing machine moves from top to bottom.

3. The sawing and drilling combined machining device according to claim 1, wherein the sawing mechanism further comprises a first movable plate, and the sawing machine is fixed to the first movable plate; one end of the first movable plate is connected to the first driving portion, and the first movable plate moves linearly up and down relative to the frame.

4. The sawing and drilling combined machining device according to claim 3, wherein the first driving portion comprises a vertical rotating component and a vertical lead screw, one end of the vertical lead screw is rotatably fixed to the vertical rotating component, and the other end of the vertical lead screw penetrates through the first movable plate and is rotatably fixed to the frame; the vertical lead screw is driven to rotate by the vertical rotating component, and the first movable plate comprises a vertical threaded hole matching the vertical lead screw.

5. The sawing and drilling combined machining device according to claim 1, wherein the drilling mechanism further comprises a second movable plate, and the drilling machine is fixed to the second movable plate; one end of the second movable plate is connected to the second driving portion, and the second movable plate moves horizontally and linearly relative to the frame.

6. The sawing and drilling combined machining device according to claim 5, wherein the second driving portion comprises a horizontal rotating component and a horizontal lead screw, one end of the horizontal lead screw is rotatably fixed to the horizontal rotating component, and the other end of the horizontal lead screw penetrates through the second movable plate and is rotatably fixed to the frame; the horizontal lead screw is driven to rotate by the horizontal rotating component, and the second movable plate comprises a horizontal threaded hole matching the horizontal lead screw.

7. The sawing and drilling combined machining device according to claim 1, wherein in the machining process of the sawing mechanism and the drilling mechanism, the clamping mechanism is fixed to the frame through a hydraulic lock, the hydraulic lock comprises a fixed portion fixed to the frame and an ejector rod for restricting the rotation of the clamping mechanism, and the ejector rod continuously presses against the clamping mechanism under hydraulic power to restrict the rotation of the clamping mechanism.

8. The sawing and drilling combined machining device according to claim 6, wherein the frame is rectangular, and the middle of the frame comprises an accommodating space for accommodating the sawing machine and the drilling machine; the first end and the second end are respectively side end plates at two ends of the accommodating space, the third end is a top end plate of the accommodating space, and the second movable plate is mounted on a bottom plate of the accommodating space in a sliding manner.

9. The sawing and drilling combined machining device according to claim 4, wherein the sawing mechanism further comprises a vertical guide pillar, at least one end of the vertical guide pillar is fixed to the frame, the first movable plate further comprises a vertical guide hole matching the vertical guide pillar, and the first movable plate moves linearly up and down along the vertical guide pillar.

10. The sawing and drilling combined machining device according to claim 8, wherein the drilling mechanism further comprises a horizontal guide block, and the horizontal guide block is fixed to the bottom plate of the accommodating space; the second movable plate further comprises a horizontal guide slot matching the horizontal guide block, and the second movable plate moves horizontally and linearly along the horizontal guide block.
